(19) United States
(12) Patent Application Publication
(10) Pub. No.: US 2025/0333254 A1
(43) Pub. Date: Oct. 30, 2025

(54) Determining a Movement Path of Kinematics for Picking up an Object from a Conveyor System

(71) Applicant: Siemens Aktiengesellschaft, Muenchen (DE)

(72) Inventors: Tino HEBER, Freiberg (DE); Kay GRAMMATKE, Hartmannsdorf (DE); Holger HÜFNER, Bautzen (DE)

(21) Appl. No.: 19/192,642

(22) Filed: Apr. 29, 2025

(30) Foreign Application Priority Data
Apr. 30, 2024 (EP) 24173454

(51) Int. Cl. B65G 47/90; B25J 9/00

(52) U.S. Cl. CPC B65G 47/905; B25J 9/0093

(57) ABSTRACT

A control device, computer program and method for determining a path of kinematics for picking up an object from a conveyor system includes providing a kinetic model depending on mass, moment of inertia or inertia tensor of the kinematics, specifying maximum drive forces and/or drive torques of drives, determining limit values for state variables of the path, as a function of the maximum drive forces and/or drive torques based on the kinetic model, the limit values being determined for a plurality of points of a working space, extrapolating a position of a virtual point on the conveyor system based on values of the position and speed and/or acceleration of the virtual point at respective sampling times, and determining setpoints for the path as a function of the determined limit values and the extrapolated position, where the movement path is modelled as a function of the position of the virtual point.

### BACKGROUND OF THE INVENTION

### 1. Field of the Invention

The invention relates to a control device and a method for determining a movement path of kinematics for picking up an object from a conveyor system.

### 2. Description of the Related Art

In many fields of application in industrial automation, objects or materials or product components are moved or transferred between processing stations and/or conveyor belts in order, for example, to run through a manufacturing or processing process or for logistical purposes or maintenance purposes within an automation installation. By way of example, objects arrive on a conveyor belt and are packed into a cardboard box or are filled with a liquid in a station or are processed by a machine tool.

A handling system is used to transfer such objects or workpieces, products etc. from a conveyor belt, on which they are randomly arranged, to another system. This is usually a system that is designed to detect the position and movement of objects and intended to record the objects, for example, a camera. A suitable path, using which the handling system transports the objects to the intended place, such as to the next processing machine, is then determined.

Applications for picking up objects from conveyor belts using robots are also known as conveyor tracking.

Handling systems are typically kinematics or multi-axis robots. By way of example, use is made of articulated-arm robots that have gripping tools on the end effector in order to pick up the objects.

In order to pick up the objects from a conveyor system, the movement of the handling system is synchronized with the conveyor belt and a suitable path needs to be determined from a pick-up point on the conveyor belt to a storage point.

Conventional solution approaches take into consideration the limit dynamics for a permissible movement by a user in the course of programming. The user has to define the path in sections so as not to infringe the dynamic limits, and at the same time belt dynamics and effects on the working space must be taken into consideration. This is a complex manual procedure.

### SUMMARY OF THE INVENTION

Against this background, it is an object of the present invention to improve path planning for kinematics for picking up an object from a conveyor system.

This and other objects and advantages are achieved in accordance with the invention by a method for determining a path movement of kinematics for picking up an object from a conveyor system, comprising providing a kinetic model of the kinematics depending on mass values, moment of inertia values or inertia tensor values of the kinematics, specifying maximum drive forces and/or maximum drive torques of drives of the kinematics, determining limit values for state variables of the path movement, comprising speed and acceleration, as a function of the maximum drive forces and/or maximum drive torques based on the kinetic model, where the limit values are determined for a multiplicity of points of a working space of the kinematics, extrapolating a position of a virtual point on the conveyor system based on values of the position, speed and acceleration of the virtual point at respective sampling times, and determining setpoints for the path movement as a function of the determined limit values and of the extrapolated position, where the path movement is modelled as a function of the position of the virtual point.

In accordance with the invention, a kinetic model is used such that maximum drive forces or maximum drive torques of the drives involved are specified as output values to compute therefrom limit values for the state variables of the path movement, i.e., the possible combinations of position, speed and acceleration to be adopted.

The limits acting for setpoint control for a prescribed path of the kinematics, that is to say in particular a maximum speed and acceleration for each position, are in turn adjusted based thereon.

If the forces and torques correspond to the maximum physical capabilities of the drives, then this gives the maximum possible limit values of the state variables at this point of the path. This makes it possible to compute dynamic limit values of the path, in particular at each or every operating point of interest, while complying with the energy limit values of the drives.

A kinetic model represents the kinetic properties of the handling system. Using the inverse kinetic model (inverse motion equation), it is possible to compute the drive forces and torques required for this state for each point on the path. Conversely, using the kinetic model, it is possible to specify a force and torque vector of the drives at each point of the path and to compute the associated state variables of the path taking into consideration suitable starting values.

By way of example, the specification of the maximum force or torque vectors results from the drive manufacturers' manufacturer specifications.

The parameters of the kinetic model incorporate masses, moments of inertia and/or inertia tensors, depending on the design of the kinematics. These parameters need to be determined for each kinematics, based on information from the robot manufacturer or measurements or estimates. Masses or inertias of the objects to be picked up are additionally incorporated into some embodiments of the method.

Specific limit values for state variables of the path movement thus result for specific kinematics used to pick up an object from a conveyor belt, for example, a six-arm robot, a portal robot, delta kinematics, or similar suitable robots, in conjunction with the drives that are used. In particular, specific limit values result for the speed and acceleration of the movement of an end effector or of a picked-up object at a point on a path prescribed for the movement.

Depending on the arrangement of the workpieces on the feed belt, provision may be made for path dynamics of the robot movement such that the path does not exceed the dynamic or energy limits of the handling system, and advantageously drives of the robot are not overloaded. This ensures that the handling system can follow the computed path and that the process sequence is not disrupted and machine components are not destroyed.

The setpoints to be output for the path movement of the kinematics are additionally determined as a function of the extrapolated position. This is achieved by extrapolating a position of a virtual point on the conveyor system to take the belt movement into consideration on a predictive basis. Solely the belt dynamics are taken into consideration, regardless of objects actually lying on a conveyor belt of the conveyor system. In particular, a speed of a belt and, accordingly, an acceleration change only rarely during regular operation. For this regular operation, the extrapolation does not result in any specific adjustment of the setpoints or any correction of advance setpoint control depending on the belt dynamics. However, as soon as an irregularity occurs during operation of the feeding belt, such as stopping or braking, this change in movement is taken into consideration in the extrapolation. The belt movements are thus extrapolated in advance for assignment to the working space of the handling system.

The advance setpoint control defines a possible path movement that complies with the limit values of the system, which are determined at each point of the path using the kinetic model, wherein the assumed position in the working space results from the extrapolation of the belt movement.

The extrapolation makes it possible to take into consideration unforeseen stopping or acceleration of the belt when picking up an object located on the conveyor system. In particular, this influences synchronization of the movement of the kinematics up to the movement of the belt or synchronous travel of the kinematics and the belt. By way of example, the extrapolation is based on values of the position, speed and acceleration of the virtual point at respective sampling times. In particular, the dynamics of the conveyor system are extrapolated independently of the objects located on the conveyor system. The extrapolation incorporates in particular the position and the dynamics of the belt, along with the time until the start of the path movement.

The proposed improvements in terms of taking into consideration dynamic changes in the belt movement result in better utilization of the drives and more energy-efficient operations. Taking into consideration jerk-limited movements further improves utilization and energy efficiency.

In accordance with one embodiment, modelling the path movement as a function of the extrapolated position on the conveyor system eliminates any explicit temporal dependency. Traditionally, the path movement is given as a function of time, in particular as a profile v(t), i.e., speed over time. By way of example, the path movement P is modelled as a function of the belt b, such that temporal influences are eliminated:

$$P = f ( b ( t ) ) = f ( b )$$

This makes it possible to specify a belt-related movement profile for the movement of the kinematics that preferably improves the processes of up-synchronization and synchronous travel between the kinematics and the belt. In particular, the belt reference significantly reduces computational effort, since the underlying temporal influences of the belt are thus eliminated.

In accordance with another embodiment, the dynamics associated with the extrapolated position are also extrapolated, in particular a speed and an acceleration of the virtual point are also extrapolated. It is thereby possible to take improved consideration of the influences of the dynamics, such as acceleration.

In accordance with a further embodiment, limit values for a jerk are also determined as a state variable. Movement profiles that are optimized for a maximum jerk are thereby also determined. Advantageously, the joints of the kinematics are thereby subjected to less stress and a movement for picking up and transferring the object is as uniform as possible.

In accordance with an embodiment, axial restrictions are also incorporated into the determination of the setpoints as a constraint. It is thereby possible to specify bounds or limits for the setpoints that need to be complied with for each axis. The setpoint control may thereby be specified in addition to the limits that result from taking into consideration maximum possible loads on individual drives. By way of example, individual axes may thus be selectively preserved or operated in a manner able to be monitored more easily.

In accordance with a further embodiment, programmed, in particular path-specific restrictions, are also incorporated into the determination of the setpoints as a constraint. By way of example, this additionally enables application-specific specifications that relate to the movement of the object to be picked up. By way of example, moving liquids in containers or sensitive objects should only be moved at a certain maximum speed or acceleration or with a certain maximum jerk.

Thus, particularly in some embodiments, path-related limits such as programmed and axial limits are also complied with, and the resulting jerk-limited path results from the minimum of all effective limits.

In accordance with an embodiment, the setpoints for the path movement are determined in advance as a function of the determined limit values, in particular for a prescribed path, and corrected online as a function of the extrapolated position, in particular for one setpoint for each cycle. A movement profile that takes into consideration the dynamic limits is thus computed continuously and on a predictive basis, for example. Adjustment of the setpoints based on an extrapolated position, which deviates from an assumed position in a certain cycle, is performed online, i.e., during operation and in particular as part of a compensation movement or corrective movement, which is specified to the kinematics by a controller. This corrective movement is also particularly specified in relation to the belt, such that both the setpoint specification via the advance profile and the corrective movement are particularly advantageously both related to the belt. In particular, if the corrective movements are longer than a sampling range or one cycle, then the temporal influences are advantageously eliminated by the belt relationship.

In accordance with another embodiment, correction of a setpoint, where the correction results from a deviation of the extrapolated position of the virtual point on the conveyor system and an actual position, is performed online during a synchronization process between the conveyor system and the kinematics or online during synchronous travel of the conveyor system and the kinematics. A typical movement of a robot-guided gripper for picking up an object from a conveyor belt consists both of what is referred to as the up-synchronization to a position in which the gripper is located above the object or the kinematics are located in a manner suitable for picking up the object and of the subsequent synchronous travel until the object has been picked up by the gripper or a similar tool with as far as possible no jerk and is no longer in contact with the belt.

In accordance with another embodiment, dynamic reserves are provided for advanced compensation in the event of prescribed restrictions being exceeded due to the setpoints corrected by the extrapolation. Thus, as a precautionary measure, the correction due to the extrapolation is prevented from exceeding the restrictions that result as a whole due to the restrictions on the determined limit values and also, for example, prescribed axial and/or programmed restrictions.

Since the extrapolation does not accurately reflect the real variables that are present later, dynamic reserves are provided. The extrapolated variables may therefore differ to a certain extent from the variables that are actually present later, without the restrictions being exceeded.

In accordance with a further embodiment, a dynamic reserve takes into consideration the compensation of the belt speed in the belt direction. It is thus possible to tolerate fluctuations in the movement of the belt in the belt direction, for example, due to fluctuations in speed.

In accordance with one embodiment, a dynamic reserve takes into consideration the compensation of the belt movement in all directions in space.

In accordance with an alternative embodiment, the kinetic model has a load torque-dependent submodel. By way of example, the submodel represents a friction characteristic curve. In order to better represent the influences of real mechanics in conveyor tracking applications, the kinetic model also contains, in addition to the known modelling of inertias, a submodel for representing friction, where the submodel is enhanced by the specific influences of load torques.

The improvements to the kinetic model with regard to the abstraction of conveyor tracking profiles further improve utilization of the drives, making operation even more energy-efficient.

By way of example, the load torque acting at the gear unit output is used as the transmitted load torque. In addition to the dependency on a speed or rotational speed, as explained in the following sections, the current frictional torque or the current frictional force changes as a function of the torque to be transmitted or of the force to be transmitted, i.e., of the load occurring. By way of example, surfaces in gear units, plain and ball bearings etc. are pressed against one another with differing force depending on the load occurring and thus depending on the torque or force transmitted, and so the frictional torques or frictional forces change. The modelling thereby advantageously becomes more accurate.

In accordance with one embodiment, the submodel has a frictional torque that is modelled as a function of a joint speed.

By way of example, an analytical representation of the frictional torque of an active joint is in accordance with the following relationship:

$${M}_{R e i b} = f ( \dot{q} )$$

The frictional torque depends, as a first approximation, on the joint speed. A further dependency of the frictional torque is taken into consideration, i.e., on the transmitted gear unit torque. The analytical representation is accordingly enhanced:

$${M}_{R e i b} = f ( \dot{q} , {M}_{L a s t} )$$

In analytical terms, the relationship may be presented as follows:

$${M}_{R e i b} = f ( \dot{q} ) * f ( {M}_{L a s t} )$$

Especially for non-linearly coupled mechanical systems, such as robots and handling systems, it is particularly advantageous to take into consideration the joint-specific load torques, because these change continuously depending on the path parameters, joint positions and moving workpieces.

To model the load torque-dependent function, it is necessary, for example, to provide a variant with a fixed reference in which an adjustment factor KL is provided for adjustment to the real mechanical conditions:

$$f ( {M}_{L a s t} ) = {M}_{L a s t} * {K}_{L}$$

By way of example, specific characteristics of the kinematics used are thus represented, these being determined in tests for a real setup.

To model the speed-dependent function, it is necessary, for example, to provide a variant with parameters m and n, where the parameters for representing static friction effects are adjusted by further measures depending on q:

$$f ( \dot{q} ) = m * \dot{q} + n$$

In accordance with one exemplary embodiment, a frictional torque of the submodel is represented by a characteristic diagram. It is thus particularly easy to read out values to be used in the model. A characteristic diagram constitutes a particularly flexible solution compared to a fixed mathematical representation. In accordance with another exemplary embodiment, intermediate values are interpolated between points of the characteristic diagram.

In one embodiment, the friction is modelled only as friction in gear units. The kinematic chain has active joints and bearing points, for example, driven by gear units, and passive ones that are not driven. The friction of the gear units of the active joints often accounts for a large part of the friction. Only the friction in the gear units is thus modelled. The modelling is thereby advantageously simplified. This may be done for rotary or linear joints.

The objects and advantages are furthermore achieved in accordance with the invention by a computer program stored in memory and comprising instructions which, when the program is executed by a processor of a computer, cause the computer to perform the method in accordance with one of the above-described embodiments.

The objects and advantages are also achieve in accordance with the invention by a control device including a processor and memory, where the control device is configured to determine a movement path of kinematics for picking up an object from a conveyor system in according with one of the above-described embodiments. The control device is configured, for example, as a, programmable logic controller (PLC) and is configured for motion control tasks such as those described here. By way of example, a superordinate controller, used separately from a robot controller, is configured for the motion tasks of the kinematics and the conveyor system as a whole.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below on the basis of exemplary embodiments with reference to the figures, in which:

FIG. 1 shows a schematic illustration illustrating a mechanical setup of a conveyor tracking application in accordance with the invention;

FIG. 2 shows a schematic illustration illustrating the method for determining a movement path in accordance with a first exemplary embodiment;

FIG. 3 shows a schematic illustration illustrating the method for determining a movement path in accordance with a second exemplary embodiment;

FIG. 4 shows a schematic illustration of a diagram of the frictional torque to be taken into consideration in a method in accordance with the prior art;

FIG. 5 shows a schematic illustration of a diagram of the frictional torque to be taken into consideration in a method in accordance with a third exemplary embodiment of the invention; and

### DETAILED DESCRIPTION OF THE EXEMPLARY EMBODIMENTS

In the figures, elements having the same function are provided with the same reference signs, unless stated otherwise.

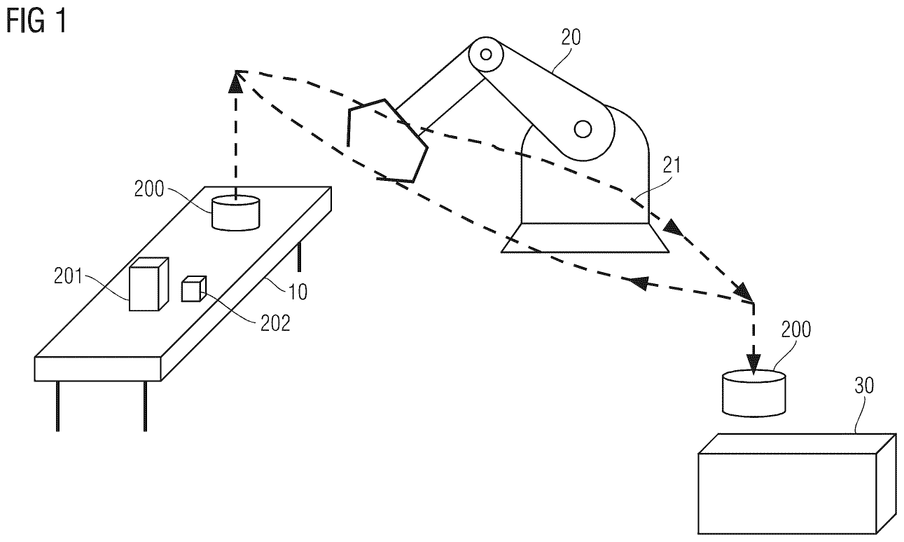

FIG. 1 shows a picking robot 20 that is intended to pick up an object 200 from a conveyor belt 10 and to move it on a planned path 21, for example, in order to place it in a cardboard box 30. By way of example, a fixedly installed six-arm robot is provided.

By way of example, the conveyor belt 10 is a circulating conveyor belt that is loaded with objects 200, 201, 202 in a starting area. By way of example, all objects that are loaded onto the conveyor belt are intended to be packed in the cardboard box 30. By way of example, the conveyor belt travels at a constant speed during normal operation. By way of example, the speed may be set flexibly and may also be adapted during operation in some embodiments.

By way of example, the objects on the conveyor belt 10 are arranged randomly, i.e., with varying distances and at varying positions.

In order to pick up the object 200 from the moving belt, the robot 20 should be operated such that the robot 20 and the conveyor belt 10 travel synchronously at least for a short period around the pick-up operation. Depending on the current speed of the belt 10 and depending on the distribution of the objects on the conveyor belt 10, it is therefore necessary to synchronize the robot 20 up to the belt 10 with subsequent synchronous travel sooner or later. If the object 200 has been picked up, then the robot 20 performed a planned movement path 21, which may be different depending on restrictions in the working space of the robot 20, in particular depending on obstacles in the space, or depending on requirements of the application.

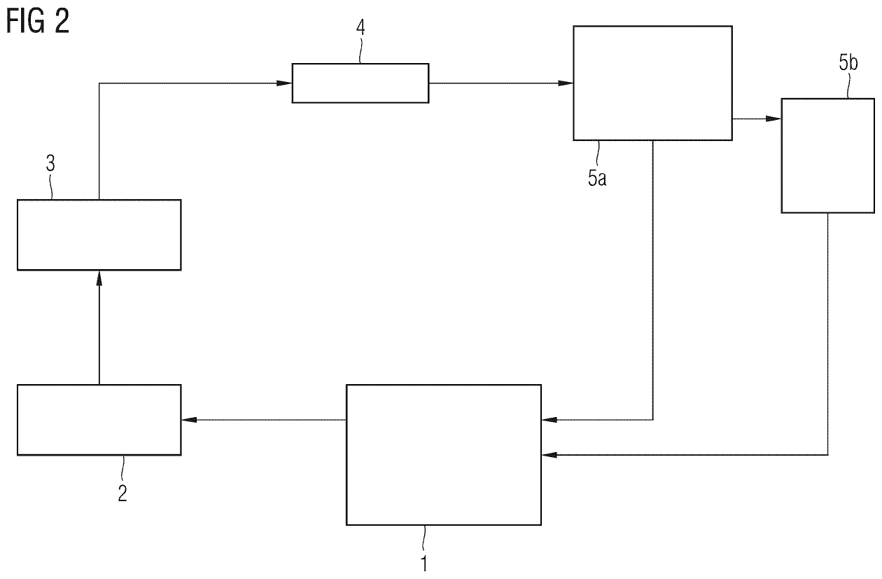

FIG. 2 illustrates a flowchart of how the movement path of the robot is adjusted in accordance with a first exemplary embodiment. The starting basis is a planned path for the robot movement with corresponding setpoint control 1, which is specified to the robot as a speed over time profile. In a first step, the profile is taken as a basis for determining the Cartesian values 2 location, speed and acceleration for each point in Cartesian space as a function of time, i.e., P(t), P′(t), P″(t). The Cartesian speed and the Cartesian acceleration are thus present. These are converted into axis values 3, i.e., into axial positions, and in turn their derivatives, via inverse kinematic transformation.

The drive forces and torques, required for the respective state, on the axes 5a are computed using the axial values 3, taking into consideration the kinetic model 4. These are output in order to perform online pilot control of the drives.

Maximum drive forces and drive torques, which are known for the axis-specific drives involved, are additionally used to determine the maximum possible limit values 5b of the state variables, which are taken into consideration in the motion control 1 as dynamic limit values of the path.

Mapping to the belt functionality is then performed, in which the limited corrected time-based profile, determined using the maximum drive forces and drive torques, is converted into a belt-related profile. Belt-related means here that the profile is given as a function of a belt position.

Depending on the extrapolated values of the conveyor belt profile and the computed belt error with a spatial reference, it is then possible to make a correction if there are changed demands on the kinematics due to a changed belt profile for the synchronization process. These corrections are implemented for each cycle.

It is therefore then possible, in addition to the corrections computed in advance due to the limitations, in particular due to the maximum axial loads, due to additional axial limitations that keep the operation on an axis below the maximum utilization, or due to programmed limitations that result from requirements of the application, such as maximum speeds, accelerations or jerk at which to be travelled, also to implement a correction to be implemented for each cycle based on the extrapolated conveyor belt behavior.

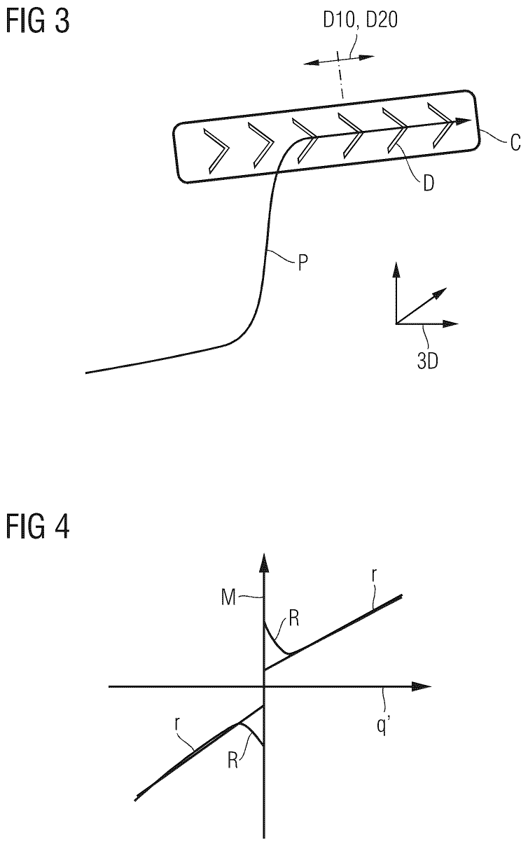

FIG. 3 illustrates the use of the dynamic reserves: By way of example, the path P is travelled by the end effector of the kinematics. The arrows D indicate the direction of movement of the conveyor belt C. Dynamic reserves are provided for advanced compensation. The belt movement itself is compensated in the direction D10 of the conveyor belt movement and counter to D20. The other reserve is provided for the general space and covers the three directions in space 3D in order additionally to take into consideration belt changes during up/down-synchronization.

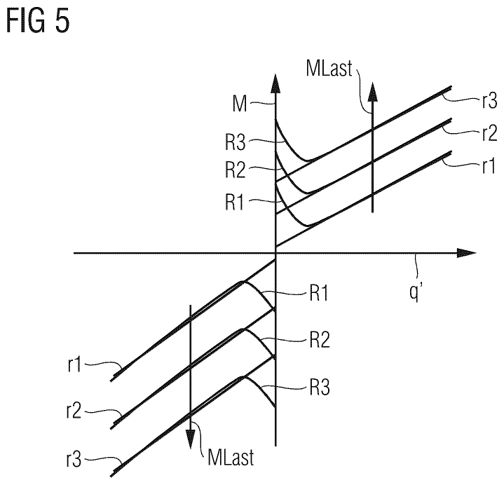

FIG. 4 shows a typical friction characteristic curve R and its abstraction r. Frictional torque M is plotted against speed q′. It is possible to see the speed dependency. At the zero crossing, the characteristic curve exhibits discontinuity due to static friction effects. Such characteristic curves for describing the behavior of kinematics are known.

FIG. 5 shows an adjustment of the friction characteristic curve used in a modelling of the kinematics, plotted as a frictional torque M against q′, which additionally exhibits a dependency on the transmitted torque MLast. FIG. 5 shows the influence of the transmitted torque MLast for three different transmitted forces: The more forces are transmitted, the higher the friction, and the friction characteristic curve shifts toward absolute higher frictional torques, with otherwise essentially analogous profiles of the friction characteristic curves R1, R2, R3. The abstracted characteristic curves r1, r2, r3 have a corresponding profile. In the event of a relatively high load on the gear unit, the mass inertias must be overcome accordingly, and so this higher friction is taken into consideration in the modelling.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for determining a movement path of kinematics for picking up an object from a conveyor system, the method comprising:
providing a kinetic model of the kinematics depending on one of mass values, moment of inertia values and inertia tensor values of the kinematics;
specifying at least one of maximum drive forces and maximum drive torques of drives of the kinematics;
determining limit values for state variables of the movement path, comprising speed and acceleration, as a function of at least one of the maximum drive forces and maximum drive torques based on the kinetic model, the limit values being determined for a plurality of points of a working space of the kinematics;
extrapolating a position of a virtual point on the conveyor system based on values of at least one (i) the position and speed and (ii) acceleration of the virtual point at respective sampling times; and
determining setpoints for the movement path as a function of the determined limit values and of the extrapolated position, the movement path being modelled as a function of the position of the virtual point.

2. The method as claimed in claim 1, wherein modelling the movement path as a function of the extrapolated position on the conveyor system eliminates any explicit temporal dependency.

3. The method as claimed in claim 1, wherein the dynamics associated with the extrapolated position are also extrapolated.

4. The method as claimed in claim 2, wherein the dynamics associated with the extrapolated position are also extrapolated.

5. The method as claimed in claim 3, wherein a speed and an acceleration of the virtual point are also extrapolated.

6. The method as claimed in claim 5, wherein a speed and an acceleration of the virtual point are also extrapolated.

7. The method as claimed in claim 1, wherein limit values for a jerk are also determined as a state variable.

8. The method as claimed in claim 2, wherein limit values for a jerk are also determined as a state variable.

9. The method as claimed in claim 1, wherein axial restrictions are also incorporated into the determination of the setpoints as a constraint.

10. The method as claimed in claim 1, wherein programmed path-specific restrictions are also incorporated into the determination of the setpoints as a constraint.

11. The method as claimed in claim 1, wherein the setpoints for the movement path are determined in advance as a function of the determined limit values, and are corrected online as a function of the extrapolated position.

12. The method as claimed in claim 11, wherein the setpoints for the movement path are for a prescribed path and for one setpoint for each cycle.

13. The method as claimed in claim 1, wherein a correction of a setpoint that results from a deviation of the extrapolated position of the virtual point on the conveyor system and an actual position is performed online during a synchronization process between the conveyor system and the kinematics or online during synchronous travel of the conveyor system and the kinematics.

14. The method as claimed in claim 1, wherein dynamic reserves are provided for advance compensation in an event of prescribed restrictions being exceeded due to the setpoints corrected by the extrapolation.

15. The method as claimed in claim 14, wherein a dynamic reserve takes into consideration the compensation of the belt speed in the belt direction.

16. The method as claimed in claim 14, wherein a dynamic reserve takes into consideration the compensation of the belt movement.

17. The method as claimed in claim 14, wherein a dynamic reserve takes into consideration the compensation of the belt movement.

18. The method as claimed in claim 1, wherein the kinetic model has a load torque-dependent submodel.

19. The method as claimed in claim 18, wherein the submodel models a frictional torque as a function of a joint speed.

20. The method as claimed in claim 18, wherein a frictional torque of the submodel is represented by a characteristic diagram via intermediate values interpolated between points of the characteristic diagram.

21. The method as claimed in claim 19, wherein a frictional torque of the submodel is represented by a characteristic diagram via intermediate values interpolated between points of the characteristic diagram.

22. A computer program stored in memory and comprising instructions which, when executed by a processor of a computer, cause the computer to perform the method as claimed in claim 1.

23. A control device configured to determine a movement path of kinematics for picking up an object from a conveyor system, the control device comprising: a processor; and
memory;
wherein the control device is further configured to:
provide a kinetic model of the kinematics depending on one of mass values, moment of inertia values and inertia tensor values of the kinematics;
specify at least one of maximum drive forces and maximum drive torques of drives of the kinematics;
determine limit values for state variables of the movement path, comprising speed and acceleration, as a function of at least one of the maximum drive forces and maximum drive torques based on the kinetic model, the limit values being determined for a plurality of points of a working space of the kinematics;
extrapolate a position of a virtual point on the conveyor system based on values of at least one (i) the position and speed and (ii) acceleration of the virtual point at respective sampling times; and
determine setpoints for the movement path as a function of the determined limit values and of the extrapolated position, the movement path being modelled as a function of the position of the virtual point.
